(19) United States
(12) Patent Application Publication
(10) Pub. No.: US 2015/0066193 A1
(43) Pub. Date: Mar. 5, 2015

(54) COMPUTING DEVICE AND METHOD FOR COMPENSATING STEP VALUES OF MACHINING DEVICE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); LU YANG, Shenzhen (CN)

(21) Appl. No.: 14/472,979

(22) Filed: Aug. 29, 2014

(30) Foreign Application Priority Data
Aug. 29, 2013 (CN) 2013103837352

(51) Int. Cl. G05B 19/402

(52) U.S. Cl. CPC G05B 19/402; G05B 2219/40416
USPC 700/166

(57) ABSTRACT

In a method for compensating step value of a processing product placed on a machining device using a computing device, a machining tool of the machining device is controlled to be moved to each benchmark point in sequence. Actual coordinate values of each benchmark point is calculated by a laser detection device of the machining device. The acquired actual coordinate values are fitted to be a benchmark plane. New coordinate values of each machining point in a machining program is acquired by rotating each of the machining points to the benchmark plane. The machining tool is controlled to move to each machining point according to the calculated new coordinate values and an actual z coordinate value of each machining point is acquired using the laser detection device. The step compensation value in Z-axis of the each machining point is calculated and transmitted to the machining device.

### CROSS-REFERENCE TO RELATED APPLICATIONS

This application claims priority to Chinese Patent Application No. 201310383735.2 filed on Aug. 29, 2013 in the State Intellectual Property Office of the People's Republic of China, the contents of which are incorporated by reference herein.

### FIELD

Embodiments of the present disclosure relate to machining technology, and particularly to a computing device and a method for compensating step values of a machining device using the computing device.

### BACKGROUND

When a computer numerical control (CNC) machining device processes a product, the processing in a Z axis direction is generally not even because thicknesses of processing materials may be inconsistent throughout the product. Furthermore, a clamping fixture of the CNC machining device is not ensured to be perfectly perpendicular to a normal vector of a machining spindle of the CNC machining device. Therefore, a large around of processing errors may be generated , causing the thickness of the processed product to be inconsistent.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a computing device including a step compensation system.

FIG. 2 is a diagrammatic view of an embodiment of a clamping fixture of a machining device.

FIG. 3 is a diagrammatic view of an embodiment of a location relationship between a laser detection device and a machining spindle in a machining device.

FIG. 4 is a diagrammatic view of an embodiment of a laser detection device in a machining device.

FIG. 5 is a block diagram of one embodiment of the step compensation system of the computing device of FIG. 1.

FIG. 6 is a flowchart of one embodiment of a method of compensating step values of the machining device using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.” It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives. The term “comprising” means “including, but not necessarily limited to”; it specifically indicates open-ended inclusion or membership in a so-described combination, group, series and the like.

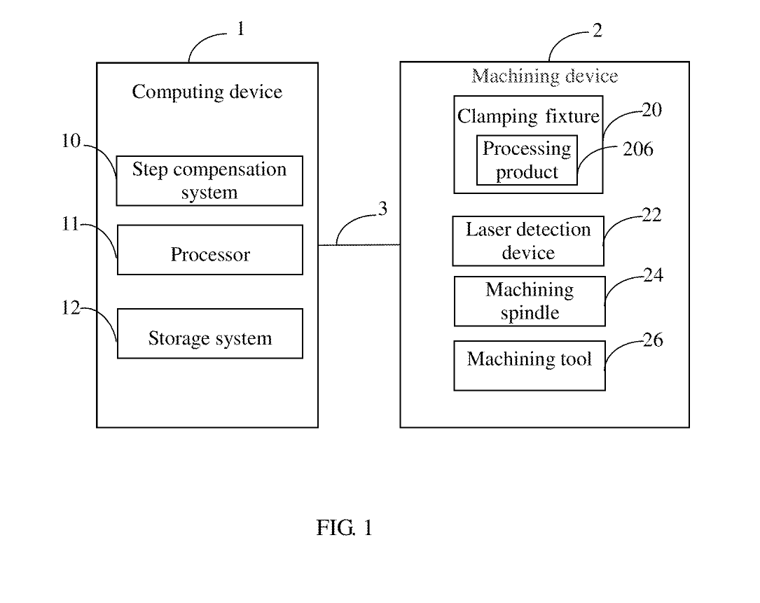

FIG. 1 is a block diagram of one embodiment of a computing device including a step compensation system. The computing device 1 includes, but is not limited to, a step compensation system 10, at least one processor 11, and a storage system 12. The at least one processor 11 executes one or more computerized codes and other applications of the computing device 1 to provide functions of the step compensation system 10. The storage system 12 can be an internal storage system, such as a random access memory (RAM) for temporary storage of information, and/or a read only memory (ROM) for permanent storage of information. The storage system 12 can also be an external storage system, such as an external hard disk, a storage card, or a data storage medium.

In one embodiment, the computing device 1 is connected to a machining device 2 through a data cable 3. The machining device 2 can be a computer numerical control (CNC) machining device. The machining device 2 executes a machining process for a processing product 206 placed on the machining device 2 by precisely programmed commands. In this embodiment, the machining device 2 includes, but is not limited to, a clamping fixture 20, a laser detection device 22, a machining spindle 24, and a machining tool 26.

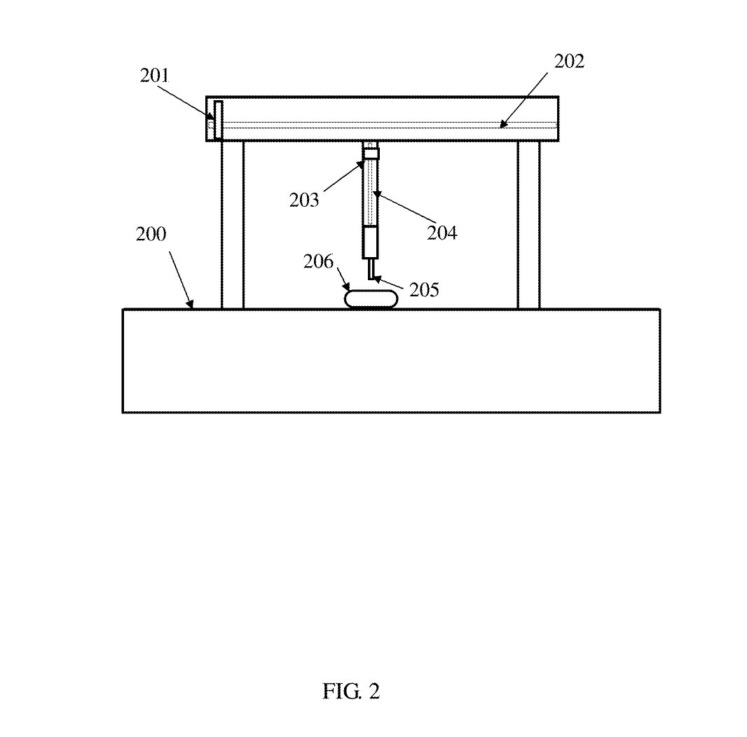

FIG. 2 is a diagrammatic view of an embodiment of a clamping fixture of a machining device. The clamping fixture 20 includes, but is not limited to, a worktable 200, an X-axis linear motor 201, an X-axis optical ruler 202, a Z-axis linear motor 203, a Z-axis optical ruler 204, and a tool optical ruler 205. The processing product 206 is placed on the worktable 200. The machining device 2 controls the machining tool 26 to move to machining positions of the processing product 206 using the X-axis linear motor 201, the X-axis optical ruler 202, the Z-axis linear motor 203, and the Z-axis optical ruler 204, and further controls the machining tool 26 to move to machining points of the processing product 206 precisely using the tool optical ruler 205.

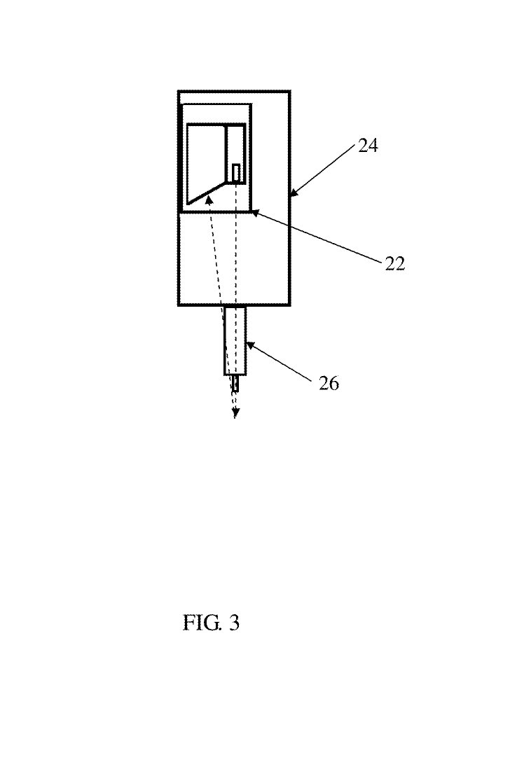

FIG. 3 is a diagrammatic view of an embodiment of location relationships between the laser detection device 22 and the machining spindle 24, and between the laser detection device 22 and the machining tool 26. In the embodiment, z coordinate value of a projection point projected on the processing product 206 by the laser detection device 22 is larger than z coordinate value of a bottom point of the machining tool 26. The projection point of the laser detection device 22 is intersected with an axis of the machining spindle 24.

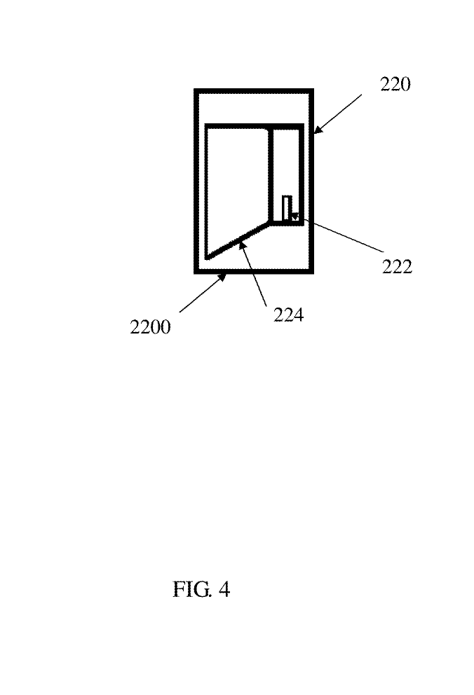

FIG. 4 is a diagrammatic view of an embodiment of the laser detection device 22. In the embodiment, the laser detection device 22 includes, but is not limited to, a protection box 220, a laser transmitter 222 and a charge-coupled device (CCD) receiver 224. The protection box 220 protects data detected by the laser detection device 22 from outside influence (for example, greasiness or dust). The bottom of the protection box 220 includes a dustproof cap 2200 which can be opened and closed. The dustproof cap 2200 is opened when the laser detection device 22 works. The laser detection device 22 is installed on the machining spindle 24 through the protection box 220. The laser transmitter 222 and the machining tool 26 are coaxial. The laser transmitter 222 emits a laser beam to be projected to the processing product 206 and reflected to the CCD receiver 224. The z coordinate value of the projection point on the processing product 206 can be determined using a triangulation calculation method according to a first distance between the projection point and the CCD receiver 224 and a second distance between the laser transmitter 222 and the CCD receiver 224.

In one embodiment, the storage system 12 can store a machining program for the processing product 206. The machining program includes original coordinate values of machining points of a machining path for the processing product 206, and original coordinate values of a plurality of machining benchmark points. The step compensation system 20 can calculate a step compensation value in Z-axis for each of the machining points using the laser detection device 22, and transmit the calculated step compensation value to the machining device 2 for processing the product correctly.

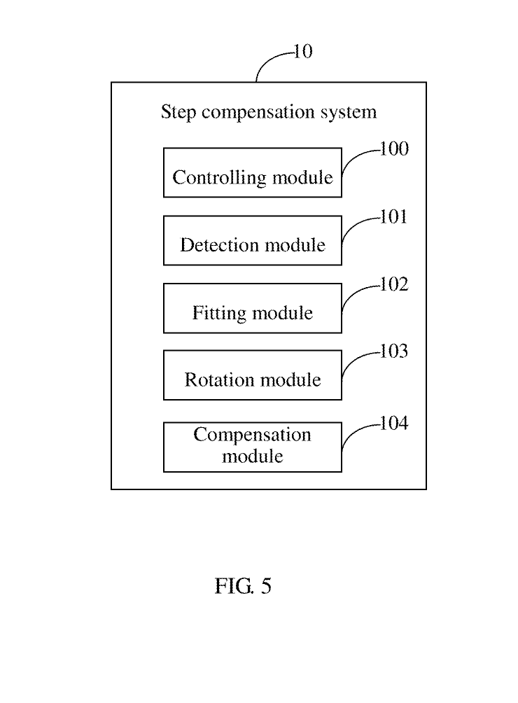

FIG. 5 is a block diagram of one embodiment of the step compensation system of the computing device of FIG. 1. In this embodiment, the step compensation system 10 includes, but is not limited to, a controlling module 100, a detection module 101, a fitting module 102, a rotation module 103, and a compensation module 104. The modules 100-104 include computerized code in the form of one or more programs that are stored in the storage system 12. The computerized code includes instructions that are executed by the at least one processor 11 to provide functions of the step compensation system 10.

The control module 100 configures to control the machining tool 26 of the machining device 2 to move to a plurality of the benchmark points of the machining program in sequence by moving the X-axis linear motor 201 and the Z-axis linear motor 203 according to the an X-axis optical ruler 202, the Z-axis optical ruler 204 and the tool optical ruler 205. In one embodiment, the step compensation system 10 controls the machining tool 26 to move to at least four benchmark points using the control module 100.

The detection module 101 configures to control the dustproof cap 2200 of the laser detection device 22 to be opened, and acquire actual coordinate values of each of the benchmark points when the machining tool 26 is moved to each of the benchmark points. In one embodiment, the detection module 101 acquires actual coordinate values of each of the benchmark points by controlling the laser detection device 22 to project to each of the benchmark points. In the embodiment, an x coordinate value of the actual coordinate values is equal to an x coordinate value of the original coordinate values of the benchmark point, and a z coordinate value of the actual coordinate values is calculated by the laser transmitter 222 and the CCD receiver 224.

The fitting module 102 configures to fit the acquired actual coordinate values to be a benchmark plane, and obtain a center point and a normal vector of the benchmark plane. In the embodiment, the fitting module 102 fits the benchmark plane according to the least-square method and a Quasi-Newton iterative method. The fitting module 102 calculates a minimum distance between the acquired actual coordinate values and a pre-fit benchmark plane according to a predetermined iterative formula of

$$“ f ( x ) = Min \sqrt{{\sum }_{n = 1}^{n} ( \sqrt{{( X 2 - X 1 )}^{2} + {( Z 2 - Z 1 )}^{2}} / n} ” ,$$

where “X1” and “Z1” in the formula represent actual coordinate values of one benchmark point, “X2” and “Z2” in the formula represent virtual coordinate values of one point on the pre-fit benchmark plane, and “n” represents a number of the benchmark points.

In the embodiment, calculation of f(x) includes the following sub-steps: Sub-step one, if f(x) calculated by predetermined iteration parameters is lower than a predetermined aligning accuracy FunX, f(x) is determined to be the minimum distance, then the procedure ends. Sub-step two, if f(x) calculated by predetermined iteration parameters is greater than or equal to the FunX, a descent direction of f(x) is calculated according to a predetermined method of Quasi-Newton iterative method. The descent direction of f(x) is a direction toward which the value of f(x) decreases. If the descent direction of f(x) does not exist, f(x) is determined to the minimum distance and the procedure ends. Sub-step three, if the descent direction of f(x) exists, a distance f(x+1) between the benchmark points after being moved an predetermined aligning step D along the descent direction and the pre-fit benchmark plane is calculated according to an equation of “f(x+1)=f(x)+|D|”. Sub-step four, if f(x+1) is lower than f(x), then the procedure returns to sub-step two. Otherwise, if f(x+1) is greater than or equal to f(x), the procedure returns to sub-step three to calculate the distance between the benchmark points after moving the predetermined aligning step D for the second time along the descent direction and the pre-fit benchmark plane.

The rotation module 103 configures to calculate new coordinate values of each of the machining points of the machining path in the machining program by rotating each of the machining points to the benchmark plane. In the embodiment, the rotation module 103 can calculate an angle difference between the benchmark plane and a preset normal plane of the machining device 2 according to the center point and the normal vector of the benchmark plane, and further rotate the machining points with the angle difference for rotating the machining points to the benchmark plane.

The compensation module 104 configures to acquire an actual z coordinate value of each of the machining points according to the new coordinate values and the laser detection device 22. In one embodiment, the compensation module firstly controls the machining tool 26 to move to each of the machining points in sequence according to the new coordinate values, and controls the laser transmitter 222 to emit the laser beam for calculating the actual z coordinate value of each of the machining points.

The compensation module 104 further configures to calculate a step compensation value in Z-axis of the each of the machining point, and transmits the calculated step compensation values in Z-axis to the machining device 2. In this embodiment, the compensation module 104 can calculate a step value in Z-axis by subtracting the actual z coordinate value from the new coordinate values of each machining point, and calculates the step compensation value in Z-axis by subtracting the step value from zero. After the machining device 2 receives the step compensation value in Z-axis of the each of the machining points from the computing device 1, the machining device 2 moves the machining tool 26 to start to process the machining points of the processing product 206 according to the step compensation value in Z-axis of the each of the machining points.

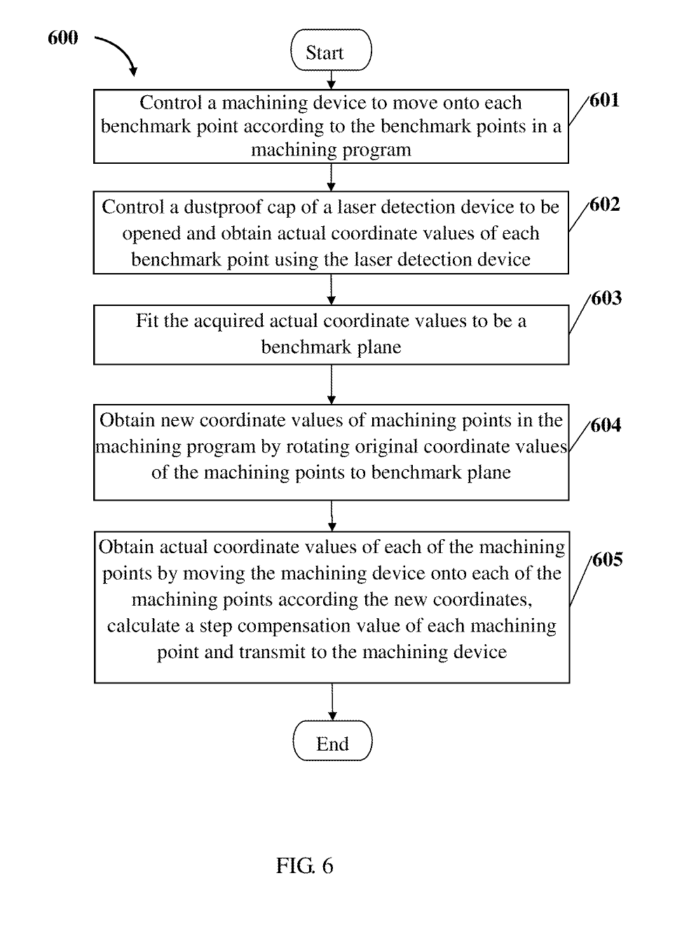

FIG. 6 is a flowchart of one embodiment of a method of compensating step values of the machining device using the computing device in FIG. 1. Depending on the embodiment, additional blocks can be added, others removed, and the ordering of the blocks can be changed. In the embodiment, the method 600 is performed by execution of computer-readable software program codes or instructions by at least one processor of a computing device. The method 600 is provided by way of example, as there are a variety of ways to carry out the method. The method 600 described below can be carried out using the configurations illustrated in FIG. 1-FIG. 5, for example, and various elements of these figures are referenced in explaining method 600. Each block shown in FIG. 6 represents one or more processes, methods or subroutines, carried out in the method 600. Additionally, the illustrated order of blocks is by example only and the order of the blocks can change according to the present disclosure. The example method 600 can begin at block 601.

In block 601, a control module controls the machining tool 26 of the machining device 2 to move to a plurality of benchmark points in a machining program of the processing product 206 in sequence by moving the X-axis linear motor 201 and the Z-axis linear motor 203 according to the X-axis optical ruler 202, the Z-axis optical ruler 204 and the tool optical ruler 205.

In block 602, a detection module controls the dustproof cap 2200 of the laser detection device 22 to be opened, and acquires actual coordinate values of each of the benchmark points when the machining tool 26 is moved to each of the benchmark points. In one embodiment, the detection module 101 acquires actual coordinate values of each of the benchmark points by controlling the laser detection device 22 to project to each of the benchmark points. In the embodiment, an x coordinate value of the actual coordinate values is equal to an x coordinate value of the original coordinate values of the benchmark point, and a z coordinate value of the actual coordinate values is calculated by the laser transmitter 222 and the CCD receiver 224.

In block 603, a fitting module fits the acquired actual coordinate values to be a benchmark plane, and obtain a center point and a normal vector of the benchmark plane. In the embodiment, the fitting module 102 fits the benchmark plane according to the least-square method and a Quasi-Newton iterative method.

In block 604, a rotation module calculates new coordinate values of each of the machining points of the machining path in the machining program by rotating each of the machining points to the benchmark plane. In the embodiment, the rotation module can calculate an angle difference between the benchmark plane and a preset normal plane of the machining device 2 according to the center point and the normal vector of the benchmark plane, and further rotate the machining points with the angle difference for rotating the machining points to the benchmark plane.

In block 605, a compensation module acquires an actual z coordinate value of each of the machining points according to the new coordinate values and the laser detection device 22, calculates a step compensation value in Z-axis of the each of the machining point, and transmits the calculated step compensation values in Z-axis to the machining device 2. In one embodiment, the compensation module firstly controls the machining tool 26 to move to each of the machining points in sequence according to the new coordinate values, and controls the laser transmitter 222 to emit the laser beam for calculating the actual z coordinate value of each of the machining points. In this embodiment, the compensation module can calculate a step value in Z-axis by subtracting the actual z coordinate value from the new coordinate values of each machining point, and calculates the step compensation value in Z-axis by subtracting the step value from zero. After the machining device 2 receives the step compensation value in Z-axis of the each of the machining points from the computing device 1, the machining device 2 moves the machining tool 26 to start to process the machining points of the processing product 206 according to the step compensation value in Z-axis of the each of the machining points.

All of the processes described above can be embodied in, and fully automated via, functional code modules executed by one or more general purpose processors such as the processor 11. The code modules can be stored in any type of non-transitory readable medium or other storage system such as the storage system 12. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-implemented method for compensating step values of a processing product placed on a machining device using a computing device, the method comprising:
controlling a machining tool of the machining device to move to each of benchmark points in a machining program of the processing product in sequence, wherein the machining program is stored in a storage system of the computing device;
acquiring actual coordinate values of each of the benchmark points by controlling a laser detection device of the machining device to emit a laser beam when the machining tool is moved to each of the benchmark points;
fitting the actual coordinate values to be a benchmark plane;
calculating new coordinate values of each of machining points in the machining program by rotating each of the machining points to the benchmark plane according to an angle difference between the benchmark plane and a preset normal plane of the machining device;
controlling the machining tool to move to each of the machining points in sequence according to the calculated new coordinate values, and acquiring an actual z coordinate value of each of the machining points using the laser detection device;
calculating a step compensation value in a Z-axis of the each of the machining point according to the actual z coordinate value of each of the machining points; and
transmitting a calculated step compensation value in the Z-axis of the each of the machining points to the machining device.

2. The method according to claim 1, wherein the laser detection device comprises a laser transmitter and a charge-coupled device (CCD) receiver, wherein the laser transmitter and the machining tool are coaxial.

3. The method according to claim 2, wherein the laser transmitter emits the laser beam to be projected to the processing product and reflected to the CCD receiver, and z coordinate value of a projection point on the processing product projected by the laser transmitter is determined according to a triangulation calculation method.

4. The method according to claim 2, wherein a z coordinate value of a projection point projected on the processing product by the laser transmitter is larger than a z coordinate value of a bottom point of the machining tool.

5. The method according to claim 2, wherein the laser detection device further comprises a protection box, and the bottom of the protection box comprises a dustproof cap, the dustproof cap is opened when the laser detection device emits the laser beam.

6. A non-transitory computer-readable storage medium storing a set of instructions, when executed by at least one processor of a computing device, cause the at least one processor to perform a method for compensating step values for a processing product placed on a machining device, the method comprising:
controlling a machining tool of the machining device to move to each of benchmark points in a machining program of the processing product in sequence, wherein the machining program is stored in a storage system of the computing device;
acquiring actual coordinate values of each of the benchmark points by controlling a laser detection device of the machining device to emit a laser beam when the machining tool is moved to each of the benchmark points;
fitting the actual coordinate values to be a benchmark plane;
calculating new coordinate values of each of machining points in the machining program by rotating each of the machining points to the benchmark plane according to an angle difference between the benchmark plane and a preset normal plane of the machining device;
controlling the machining tool to move to each of the machining points in sequence according to the calculated new coordinate values, and acquiring an actual z coordinate value of each of the machining points using the laser detection device;
calculating a step compensation value in a Z-axis of the each of the machining point according to the actual z coordinate value of each of the machining points; and
transmitting a calculated step compensation value in the Z-axis of the each of the machining points to the machining device.

7. The storage medium according to claim 6, wherein the laser detection device comprises a laser transmitter and a charge-coupled device (CCD) receiver, wherein the laser transmitter and the machining tool are coaxial.

8. The storage medium according to claim 7, wherein the laser transmitter emits the laser beam to be projected to the processing product and reflected to the CCD receiver, and z coordinate value of a projection point on the processing product projected by the laser transmitter is determined according to a triangulation calculation method.

9. The storage medium according to claim 7, wherein a z coordinate value of a projection point projected on the processing product by the laser transmitter is larger than a z coordinate value of a bottom point of the machining tool.

10. The storage medium according to claim 7, wherein the laser detection device further comprises a protection box, the bottom of the protection box comprises a dustproof cap, and the dustproof cap is opened when the laser detection device emits the laser beam.

11. A computing device being connected to a machining device, the computing device comprising:
at least one processor; and
a storage system storing one or more programs, which when executed by the at least one processor, cause the at least one processor to:
control a machining tool of the machining device to move to each of benchmark points in a machining program of the processing product in sequence, wherein the machining program is stored in the storage system;
acquire actual coordinate values of each of the benchmark points by controlling a laser detection device of the machining device to emit a laser beam when the machining tool is moved to each of the benchmark points;
fit the actual coordinate values to be a benchmark plane;
calculate new coordinate values of each of machining points in the machining program by rotating each of the machining points to the benchmark plane according to an angle difference between the benchmark plane and a preset normal plane of the machining device;
control the machining tool to move to each of the machining points in sequence according to the calculated new coordinate values, and acquire an actual z coordinate value of each of the machining points using the laser detection device;
calculate a step compensation value in a Z-axis of the each of the machining point according to the actual z coordinate value of each of the machining points; and
transmit a calculated step compensation value in the Z-axis of the each of the machining points to the machining device.

12. The computing device according to claim 11, wherein the laser detection device comprises a laser transmitter and a charge-coupled device (CCD) receiver, wherein the laser transmitter and the machining tool are coaxial.

13. The computing device according to claim 12, wherein the laser transmitter emits the laser beam to be projected to the processing product and reflected to the CCD receiver, and z coordinate value of a projection point on the processing product projected by the laser transmitter is determined according to a triangulation calculation method.

14. The computing device according to claim 12, wherein a z coordinate value of a projection point projected on the processing product by the laser transmitter is larger than a z coordinate value of a bottom point of the machining tool.

15. The computing device according to claim 12, wherein the laser detection device further comprises a protection box, the bottom of the protection box comprises a dustproof cap, and the dustproof cap is opened when the laser detection device emits the laser beam.
